(19) United States
(12) Patent Application Publication
(10) Pub. No.: US 2019/0010948 A1
(43) Pub. Date: Jan. 10, 2019

(54) ELECTRONIC FAN AND METHOD FOR CONTROLLING THE ELECTRONIC FAN

(71) Applicants: Fu Tai Hua Industry (Shenzhen) Co., Ltd., Shenzhen (CN); HON HAI PRECISION INDUSTRY CO., LTD., New Taipei (TW)

(72) Inventors: XIAN QIAN, Shenzhen (CN); CHEN-JING ZHAN, Shenzhen (CN)

(21) Appl. No.: 15/690,181

(22) Filed: Aug. 29, 2017

(30) Foreign Application Priority Data
Jul. 6, 2017 (CN) 201710545634.9

(51) Int. Cl. F04D 25/10; G01J 5/00; F04D 27/00

(52) U.S. Cl. CPC F04D 25/105; F04D 27/00; G01J 5/0025

(57) ABSTRACT

A method for controlling an electronic fan is provided. The method detects whether an human body is in the vicinity around the electronic fan by an infrared sensor, controls a first driving unit to swing a fan head of the electronic device to make the fan head face the human body, and controls a second driving unit to rotate blades of the fan head to generate breeze onto the human body.

### CROSS-REFERENCE TO RELATED APPLICATIONS

This application claims priority to Chinese Patent Application No. 201710545634.9 filed on Jul. 6, 2017, the contents of which are incorporated by reference herein.

### FIELD

The subject matter herein generally relates to electronic products, especially relates to an electronic fan and a method for controlling the electronic fan.

### BACKGROUND

Traditional electronic fan has two working modes, for example, a swing mode and a fixed mode. When the electronic fan works in the swing mode, the air receiving time from the electronic fan per receiving position is short. When the electronic fan works in the fixed mode, the single receiving position determined by the electronic fan is limited. Therefore, the experience of an existing electronic fan to people needs to be improved.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an exemplary embodiment of an electronic fan.

FIG. 2 is a block diagram of an exemplary embodiment of a system for controlling the electronic fan of FIG. 1.

FIG. 3 is a flowchart of an exemplary embodiment of a method for controlling the electronic fan of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” exemplary embodiment in this disclosure are not necessarily to the same exemplary embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series, and the like.

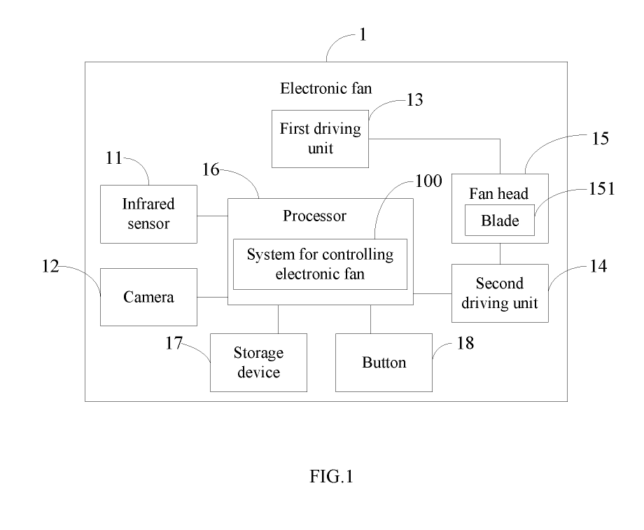

FIG. 1 illustrates an exemplary embodiment of an electronic fan 1. The electronic fan 1 includes, but is not limited to, at least one infrared sensor 11, a camera 12, a first driving unit 13, a second driving unit 14, a fan head 15, a processor 16, a storage device 17, and a button 18. The processor 16 connects to the infrared sensor 11, the camera 12, the first driving unit 13, the second driving unit 14, and the storage device 17.

The infrared sensor 11 can detect human body within a preset range. For example, the preset range can be an effective detecting range of the infrared sensor 11. In at least one exemplary embodiment, the electronic fan 1 includes a number of infrared sensors 11. The number of the infrared sensors 11 are mounted on the fan head 15. The camera 12 acquires images around the electronic fan 1. For example, the images can include human body. The first driving unit 12 can drive the fan head 15 to rotate. In at least one exemplary embodiment, the first driving unit 13 can be a steering motor. The first driving unit 13 can drive the fan head 15 to rotate leftward and rightward. In another embodiment, the first driving unit 13 can drive the fan head 15 to rotate upward and downward. In at least one exemplary embodiment, the fan head 15 includes three blades 151. The second driving unit 14 is used to drive the blades 151 of the fan head 15 to rotate to generate wind. In at least one exemplary embodiment, the second driving unit 14 can be a fan blade motor.

The storage device 17 stores program code and data of the electronic fan 1. For example, the storage device 17 stores a preset face image which is an image in which the user's face is facing the camera 12, that is, the user is facing the electronic fan 15. In at least one exemplary embodiment, the storage device 17 can include various types of non-transitory computer-readable storage mediums. For example, the storage device 17 can be an internal storage system of the electronic fan 1, such as a flash memory, a random access memory (RAM) for temporary storage of information, and/or a read-only memory (ROM) for permanent storage of information. The storage device 17 can also be an external storage system, such as a hard disk, a storage card, or a data storage medium. The processor 16 is used to detect whether a human body is in the vicinity around the electronic fan 1, and control the first driving unit 13 to rotate to make the fan head 15 face to the human body when detecting the human body. In at least one exemplary embodiment, the processor 16 can be a central processing unit (CPU), a microprocessor, or other data processor chip that performs functions of a system 100 for controlling the electronic fan 1.

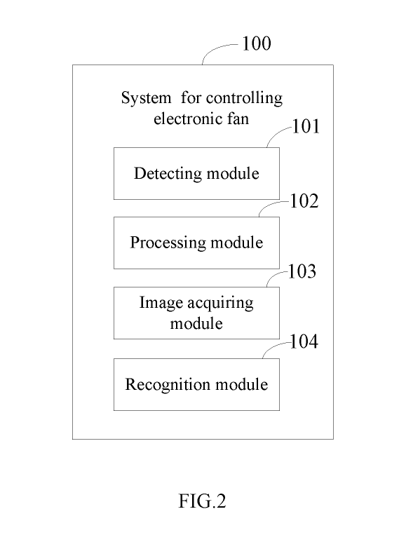

FIG. 2 illustrates the system 100 for controlling the electronic fan 1. The system 100 includes a number of modules, which are a collection of software instructions which can be executed by the processor 16. In the exemplary embodiment, the modules can include, but are not limited to, a detecting module 101, a processing module 102, an image acquiring module 103, and a recognition module 104.

The detecting module 101 controls the infrared sensor 11 to detect whether an human body is in the vicinity around the electronic fan 1.

When the detecting module 101 detects the human body, the processing module 102 controls the first driving unit 13 to swing the fan head 15 to make the fan head 15 face the human body, and further controls the second driving unit 14 to rotate the blades 151 of the fan head 15 to generate wind. In at least one exemplary embodiment, the detecting module 101 further detects whether the fan head 15 is facing the human body. When the detecting module detects that the fan head 15 is directly facing the human body, the processing module 102 controls the first driving unit 13 to stop rotating the fan head 15. In another embodiment, when the detecting module detects that the fan head 15 is facing the human body, the processing module 102 controls the first driving unit 13 to rotate the fan head 15 within a preset angle range.

In at least one exemplary embodiment, when the detecting module 101 detects that no human body is in the vicinity around the electronic fan 1, the processing module 102 controls the first driving unit 13 to stop swinging the fan head 15.

In at least one exemplary embodiment, the image acquiring module 103 controls the camera 12 to shoot a target image including face of the human body, and acquire the target image when the detecting module 101 detects the human body.

The recognition module 104 recognizes the face included in the target image acquired by the image acquiring module 103, and determines whether the human body is facing the electronic fan 15 by analyzing the face. In at least one exemplary embodiment, when the recognition module 104 recognizes a face from the target image, the recognition module 104 compares the face with the preset face image stored in the storage device 17 and determines that the human body is facing the electronic fan 15 when the recognized face is matched with the preset face image. When the recognized face is not matched with the preset face image, the recognition module 104 determines that the human body is not facing the electronic fan 15. In at least one exemplary embodiment, the preset face image is an image in which the user's face is facing the camera, that is, the user is facing the electronic fan 15. Namely, when the recognized face image is matched with front of user's face, the recognition module 104 determines that the human body is facing the electronic fan 15.

In at least one exemplary embodiment, when the human body is not facing the electronic fan 15, the processing module 102 controls the first driving unit 13 to swing the electronic fan 15 to make the electronic fan 15 point towards the human body, and controls the second driving unit 14 to rotate the blades 151 of the electronic fan 15.

In at least one exemplary embodiment, the processing module 102 further controls the first driving unit 13 to stop swinging the electronic fan 15 and controls the second driving unit 14 to rotate the blades 151 of the electronic fan 15 in response to pressing the button 18.

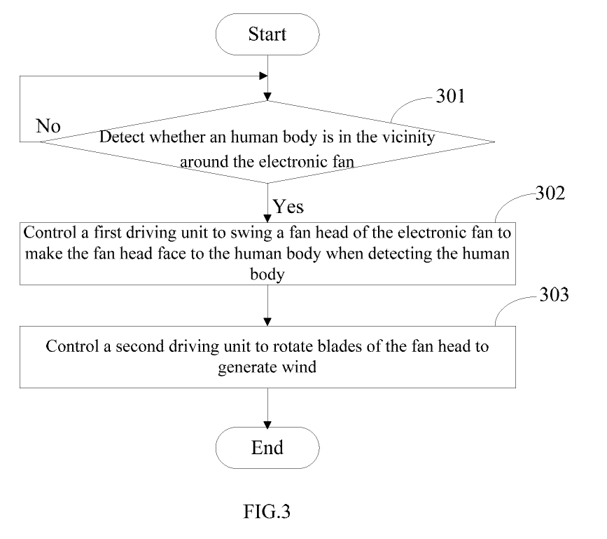

FIG. 3 illustrates a flowchart of an exemplary embodiment of method for controlling an electronic fan. The method is provided by way of example, as there are a variety of ways to carry out the method. The method described below can be carried out using the configurations illustrated in FIGS. 1-2, for example, and various elements of these figures are referenced in explaining the example method. Each block shown in FIG. 3 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 801.

At block 301, the electronic fan controls an infrared sensor to detect whether an human body is in the vicinity around the electronic fan.

At block 302, the electronic fan controls a first driving unit to swing a fan head of the electronic fan to make the fan head face to the human body when detecting the human body.

At block 303, the electronic fan controls a second driving unit to rotate blades of the fan head to generate wind.

In at least one exemplary embodiment, the method further includes: the electronic fan detects whether the fan head is facing to the human body, and controls the first driving unit to stop rotating the fan head when detecting that the fan head is facing to the human body.

In at least one exemplary embodiment, the method further includes: the electronic fan controls a camera to shoot a target image including a face of the human body and acquires the target image when detecting the human body, recognizes the face included in the target image, and determines whether the human body is facing to the electronic fan by analyzing the face.

In at least one exemplary embodiment, when recognizing the face from the target image, the electronic fan compares the face with a preset face image stored in a storage device and determines that the human body faces the electronic fan when the recognized face is matched with the preset face image. In at least one exemplary embodiment, the preset face image is an image in which the user's face is facing the camera, that is, the user is facing the electronic fan.

In at least one exemplary embodiment, the method further includes: the electronic fan controls the first driving unit to stop swinging the electronic fan and controls the second driving unit to rotate the blades of the electronic fan in response to pressing a button.

It should be emphasized that the above-described exemplary embodiments of the present disclosure, including any particular exemplary embodiments, are merely possible examples of implementations, set forth for a clear understanding of the principles of the disclosure. Many variations and modifications can be made to the above-described exemplary embodiment(s) of the disclosure without departing substantially from the spirit and principles of the disclosure. All such modifications and variations are intended to be included herein within the scope of this disclosure and protected by the following claims.

What is claimed is:

1. An electronic fan comprising:
infrared sensor configured to detect a human body within a preset range;
a fan head comprising a plurality of blades;
a first driving unit;
a second driving unit;
a processor coupled to the infrared sensor, the fan head, the first driving unit, and the second driving unit; and
a non-transitory storage medium coupled to the processor and configured to store a plurality of instructions, the plurality of instructions to be executed by the processor to cause the electronic fan to:
control the infrared sensor to detect whether an human body is in the vicinity around the electronic fan;
control the first driving unit to swing the fan head to make the fan head face to the human body; and
control the second driving unit to rotate the plurality of blades of the fan head to generate wind.

2. The electronic fan as recited in claim 1, wherein the electronic fan further a camera configured to shoot images around the electronic fan, the plurality of instructions further cause the electronic fan to:
control the camera to shoot a target image comprising a face of the human body;
acquire the target image;
recognize the face of the target image; and
determine whether the human body is facing to the electronic fan by analyzing the face.

3. The electronic device as recited in claim 2, wherein the plurality of instructions further cause the electronic fan to:
compare the face with a preset face image when recognizing the face from the target image, wherein the preset face image is an image in which user's face is facing the camera;
determine that the human body faces the electronic fan when the recognized face is matched with the preset face image; or
determine that the human body is not facing the electronic fan when the recognized face is not matched with the preset face image.

4. The electronic device as recited in claim 1, wherein the electronic fan further a button, the plurality of instructions further cause the electronic fan to:
control the first driving unit to stop swinging the electronic fan and control the second driving unit to rotate the plurality of blades of the electronic fan in response to pressing the button.

5. The electronic device as recited in claim 1, wherein the plurality of instructions further cause the electronic fan to:
control the first driving unit to stop swinging the fan head when detecting that no human body is in the vicinity around the electronic fan.

6. The electronic device as recited in claim 1, wherein the plurality of instructions further cause the electronic fan to:
control the first driving unit to stop rotating the fan head when detecting that the fan head is facing to the human body.

7. The electronic device as recited in claim 1, wherein the plurality of instructions further cause the electronic fan to:
control the first driving unit to rotate the fan head within a preset angle range when detecting that the fan head is facing to the human body.

8. The electronic device as recited in claim 1, wherein the first driving unit can be a steering motor, the second driving unit can be a fan blade motor.

9. A method for controlling an electronic fan, comprising:
control an infrared sensor to detect whether an human body is in the vicinity around the electronic fan;
control a first driving unit to swing a fan head of the electronic device to make the fan head face to the human body; and
control a second driving unit to rotate a plurality of blades of the fan head to generate wind.

10. The method as recited in claim 9, wherein the method further comprising:
control a camera to shoot a target image comprising a face of the human body;
acquire the target image;
recognize the face of the target image; and
determine whether the human body is facing to the electronic fan by analyzing the face.

11. The method as recited in claim 10, wherein the method further comprising:
compare the face with a preset face image when recognizing the face from the target image, wherein the preset face image is an image in which user's face is facing the camera;
determine that the human body is facing the electronic fan when the recognized face is matched with the preset face image; or
determine that the human body is not facing the electronic fan when the recognized face is not matched with the preset face image.

12. The method as recited in claim 9, wherein the method further comprising:
control the first driving unit to stop swinging the electronic fan and control the second driving unit to rotate the plurality of blades of the electronic fan in response to pressing the button.

13. The method as recited in claim 9, wherein the method further comprising:
control the first driving unit to stop swinging the fan head when detecting that no human body is in the vicinity around the electronic fan.

14. The method as recited in claim 9, wherein the method further comprising:
control the first driving unit to stop rotating the fan head when detecting that the fan head is facing to the human body.

15. The method as recited in claim 9, wherein the method further comprising:
control the first driving unit to rotate the fan head within a preset angle range when detecting that the fan head is facing to the human body.
